(19) United States
(12) Patent Application Publication
(10) Pub. No.: US 2007/0009117 A1
(43) Pub. Date: Jan. 11, 2007

(54) Fetal environment device

(76) Inventor: Robert E. Laflamme, Goffstown, NH (US)

Correspondence Address: DAVIS & BUJOLD, P.L.L.C., 112 PLEASANT STREET, CONCORD, NH, 03301, US

(21) Appl. No.: 11/178,891

(22) Filed: Jul. 11, 2005

(51) Int. Cl. G09F 27/00

(52) U.S. Cl. 381/124

(57) ABSTRACT

A fetal environment device including an adjustable belt assembly and a communications section having an electronics unit, a music playback unit at least one wearer earphone and at least one fetal speaker located in a stomach region of the wearer to transmit the music to a fetus, a microphone to transmit a wearer's voice to the fetus through the fetal speaker, and a fetal microphone in close proximity to a stomach region of the wearer to provide the fetal heartbeat sound to the wearer.

### FIELD OF THE INVENTION

The present invention relates to a device for establishing and maintaining communication and a shared environment between a mother and a fetus and, in particular, a device for promoting bonding between a mother and a fetus, as well as the father, siblings, family, friends and others.

### BACKGROUND OF THE INVENTION

There are a significant number of medical and child development authorities who hold the general opinion that certain forms of stimulation of a developing fetus by external influences, such as certain classical music or the mother's voice, is beneficial for the child's later development, including post-natal bonding with the mother. It is also believed that for at least some mothers an increased pre-natal awareness and involvement with the child, such as listening to the fetal heartbeat, significantly assists the mother in bonding with the child. The means for accomplishing such communications between the outside world and the fetus and between the mother and fetus, such as music systems and conventional fetal monitoring systems, have been generally unsatisfactory, however, due to cost, complexity of use and inconvenience.

The present invention addresses these and other related problems of the prior art.

### SUMMARY OF THE INVENTION

The present invention is directed to a fetal environment device that includes a belt assembly and a communications section wherein first and second belt sections extend from first and second sides of the communications section and including mating fasteners for securing the communications section about the waist of a pregnant wearer. The belt sections may also include an elasticized section to provide a resilient connection between the first and second belt sections.

The communications section includes a communications module having an electronics unit, a music playback unit selectively providing music to a music input of the electronics unit, at least one earphone connected from an earphone output of the electronics unit for providing the music to the wearer, at least one fetal speaker connected from a music output of the electronics unit and located in the communications section in close proximity to a stomach region of the wearer to transmit the music to a fetus through the wearer's body, a microphone accessible to the wearer and connected to an input of the electronics unit to transmit a wearer's voice to the fetus through the at least one fetal speaker, and at least one fetal microphone connected to an input of the electronics unit and located in the communications section in close proximity to a stomach region of the wearer to receive a fetal heartbeat sound transmitted to the at least fetal microphone through the wearer's body and to provide the fetal heartbeat sound to the wearer through the at least one earphone.

The communications section will also include a power pack for providing electrical power to the communications module and a control panel allowing the wearer to control functions of the communications module.

The device may also include a stress relief module located in one of the first and second belt sections to be positioned against the wearer's back, including a heating unit, a vibrating unit and one or more power packs for providing electrical power to the heating unit and vibrating unit and a power pack for providing electrical power to the heating unit.

### BRIEF DESCRIPTION OF THE DRAWING(S)

The invention will now be described, by way of example, with reference to the accompanying drawings in which:

FIG. 1 is a diagrammatic representation of a fetal environment fetal device;

FIG. 2 is a diagrammatic representation of a communications module of a fetal environment device; and,

FIG. 3 is a diagrammatic representation of a stress relief module of fetal environment device.

### DETAILED DESCRIPTION OF THE INVENTION

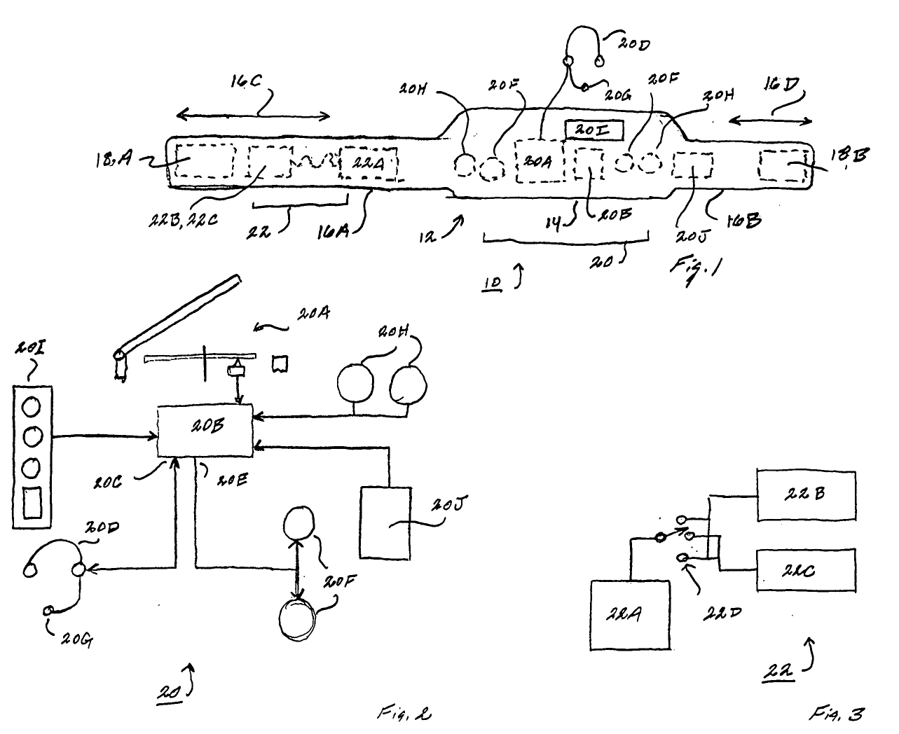

Referring to FIG. 1, therein is shown a diagrammatic representation of a Fetal Environment Device 10 of the present invention for providing communications between the fetus and the external world, including the mother, and for providing a shared environment between the mother and fetus, as well as the father, siblings, family, friends and others.

As illustrated, a Fetal Environment Device 10 includes a Belt Assembly 12 that includes a Communications Section 14 and Belt Sections 16A and 16B that are attached to either side of Communications Section 14. As indicated generally in FIG. 1, Belt Sections 16A and 16B include mating Fasteners 18A and 18B for securing the Fetal Environment Device 10 around the mother's waist with the Communications Section 14 generally centered over the region of the fetus.

Fasteners 18A and 18B may be comprised, for example, of hook and loop type fasteners, such as marketed under the trademark Velcro, and either or both of Belt Sections 16A and 16B may include an Elasticized Section 16C or 16D to provide a comfortable but secure resilient attachment between Belt Sections 16A and 16B. In addition, and although not shown in detail, Communications Section 14 and Belt Sections 16A and 16B may be covered with a suitable fabric, such as a flannel type material or blanket material. The inner side of Communications Section 14 and Belt Sections 16A and 16B may also be provided with an additional padding layer, except as required for the functions of Communications Section 14 as described below.

It must be noted that in the embodiment of a Fetal Environment Device 10 illustrated in FIG. 1 Belt Sections 16A and 16B are shown is asymmetric. As such, and as will be apparent, the fastening between Belt Sections 16A and 16B by Fasteners 18A and 18B would normally fall along one side of the mother's waist, which would typically be more convenient for a pregnant woman. It will be understood, however, that the two halves of the belt could by symmetric so that the junction between the two halves of the belt could fall, for example, in the center of the woman's back. In yet other embodiments Belt Sections 16A and 16B could be asymmetric to the extent that the fastening would be at one side of the Communications Section 14 so that the Fetal Environment Device 10 would effectively be front fastening.

Referring now to FIGS. 1 and 2, Communications Section 14 of a Fetal Environment Device 10 contains a Communications Module 20 that performs a number of communications type functions. For example, Communications Module 20 will typically include a Music Playback Unit 20A, such as a CD player unit or an Apple iPod unit, with an associated Electronics Unit 20B containing, for example, amplifiers, microphone input circuits and other appropriate electronic circuits of the types usual for use with the elements of Communications Module 20.

As indicated, Electronics Unit 20B includes Earphone Outputs 20C driving conventional Earphones 20D and Speaker Outputs 20E driving a pair of Fetal Speakers 20F. As indicated in FIG. 1, Fetal Speakers 20F are mounted to the inner side of Communications Section 14 and typically on either side of Communications Section 14 to come into contact or close proximity with the mother's stomach in the region of the fetus when the mother is wearing the Fetal Environment Device 10. The arrangement of Fetal Speakers 20F thereby allows a sound output of Electronics Unit 20B, such as music from Music Playback Unit 20A, to be transmitted into and through the mother's body to the fetus while the mother may listen to the same sounds through Earphones 20D.

As also illustrated, Earphones 20D may further include a Microphone 20G connected to a microphone input of Electronics Unit 20B, thereby allowing the mother to speak into the Microphone 20G and for her voice to be transmitted through Electronics Unit 20B and Fetal Speakers 20F to the fetus, thereby allowing direct communication of the mother's voice to the fetus during the pregnancy, as well as the voices of the father, siblings, family, friends and others.

In a like manner, Communications Module 20 may further include Fetal Microphones 20H typically located, as in the case of Fetal Speakers 20F, on either side of Communications Section 14 to come into contact or close proximity with the mother's stomach in the region of the fetus when the mother is wearing the Fetal Environment Device 10. Fetal Microphones 20H are provided to detect sounds from the fetus, that is and specifically, the fetal heartbeat, and to transmit the heartbeat to the mother through amplifiers of Electronics Unit 20B and Earphones 20D.

Lastly, and also as illustrated, Communications Module 20 will include a Control Panel 20I providing control elements, such as switches and volume sliders, to allow the mother to select the desired communications mode, such as listening to music, listening to the fetal heartbeat, or speaking to the fetus, and to control the sound volume as desired and necessary. The Communications Module 20 will also include a Power Pack 20J, which will typically be comprised of replaceable or rechargeable batteries having a capacity to allow several hours of use.

It should also be noted that Power Pack 20J and the other elements of Communications Module 20 will typically be located in Communications Section 14 in positions selected so that, for purposes of comfort, the mother would not normally press or lie on the components of Communications Module 20. Also, it should be noted that the components of Communications Module 20, which may be comprised of separate elements or integrated into a single unit or wherein some elements may be integrated with one another, will typically be arranged to be removable from Communications Section 14 to allow cleaning of the Fetal Environment Device 10. That is, and for example, the unit or units comprising Communications Module 20 may be contained in one or more corresponding appropriately formed pockets and retained therein by, for example, hook and loop fasteners.

Next, and as illustrated in FIG. 3, the Fetal Environment Device 10 may further include a Stress Relief Module 22 designed, in a present embodiment, to provide some relief and comfort from back strain that frequency occurs during pregnancy. In one embodiment, Stress Relief Module 22 could include a Power Pack 22A, such as a replaceable or rechargeable battery pack, a relatively low power Heater Unit 22B, a relatively low power Vibrator Unit 22C, and a Switch 22D allowing selection of either or both of Heater Unit 22B and Vibrator Unit 22C. As indicated in FIG. 1, at least the Heater Unit 22B and the Vibrator Unit 22C are located in one or the other of Belt Sections 16A and 16B to normally reside in the region of the small of the wearer's back while Power Pack 22A and Switch 22D would be located at the side or towards the front of the Fetal Environment Device 10 for ease of operation and so that the wearer would not normally lie on the Power Pack 22A and Switch 22D. It should also be noted that if the wiring between Power Pack 22A and Switch 22D and the Vibrator Unit 22C and Heater Unit 22B runs through Elasticized Section 16C or 16D, the wiring would normally be arranged in a zig-zag or accordion pattern to allow expansion or contraction of the wiring path. Lastly, it should be noted that the Heater Unit 22B, for example, could be replaced by a non-powered heating device, such as a flexible container filled with a malleable heatable material, such as a heatable granular or fluid material, thus reducing the power requirements or, if the Vibrator Unit 22C is eliminated, eliminating the need for Power Pack 22A and Switch 22D.

Since certain changes may be made in the above described invention without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/we claim:

1. A fetal environment device, comprising:
a belt assembly,
a communications section, and
first and second belt sections extending from first and second sides of the communications section and including mating fasteners for securing the communications section about the waist of a pregnant wearer,
a communications module located in the communications section and including
an electronics unit,
a music playback unit selectively providing music to a music input of the electronics unit,
at least one earphone connected from an earphone output of the electronics unit for providing the music to the wearer,
at least one fetal speaker connected from a music output of the electronics unit and located in the communications section in close proximity to a stomach region of the wearer to transmit the music to a fetus through the wearer's body,
a microphone accessible to the wearer and connected to an input of the electronics unit to transmit a wearer's voice to the fetus through the at least one fetal speaker,
at least one fetal microphone connected to an input of the electronics unit and located in the communications section in close proximity to a stomach region of the wearer to receive a fetal heartbeat sound transmitted to the at least fetal microphone through the wearer's body and to provide the fetal heartbeat sound to at least one of the wearer and another through the at least one earphone,
a power pack located in the communications section for providing electrical power to the communications module, and
a control panel allowing the wearer to control functions of the communications module.

2. The fetal environment device of claim 1, further comprising:
a stress relief module located in one of the first and second belt sections to be positioned against the wearer's back, including
a heating unit, and
a power pack for providing electrical power to the heating unit.

3. The fetal environment device of claim 1, further comprising:
a stress relief module located in one of the first and second belt sections to be positioned against the wearer's back, including
a pocket for receiving a non-powered heating device, the heating device including a flexible container filled with a malleable heatable material.

4. The fetal environment device of claim 1, further comprising:
a stress relief module located in one of the first and second belt sections to be positioned against the wearer's back, including
a vibrating unit, and
a power pack for providing electrical power to the vibrating unit.

5. The fetal environment device of claim 1 wherein:
at least one of the first and second belt sections includes an elasticized section to provide a resilient connection between the first and second belt sections.
